(19) United States
(12) Patent Application Publication
(10) Pub. No.: US 2002/0067275 A1
(43) Pub. Date: Jun. 6, 2002

(54) Diaper with acidity indicator

(76) Inventor: Deanna Long, Charlotte, NC (US)

Correspondence Address: HENDERSON & STURM LLP, 1213 MIDLAND BUILDING, 206 SIXTH AVENUE, DES MOINES, IA, 50309-4076, US

(21) Appl. No.: 09/727,882

(22) Filed: Dec. 1, 2000

(51) Int. Cl. G08B 21/00

(52) U.S. Cl. 340/603; 340/573.1

(57) ABSTRACT

A diaper including an acidity indicator such as a pH indicator strip imbedded on the inside surface of the diaper underneath a translucent cushion layer that will keep the skin dry. Abnormal acidity of the urine alerts parents to the possibility of a urinary tract infection before it advances to the stage where it can attack the baby's body.

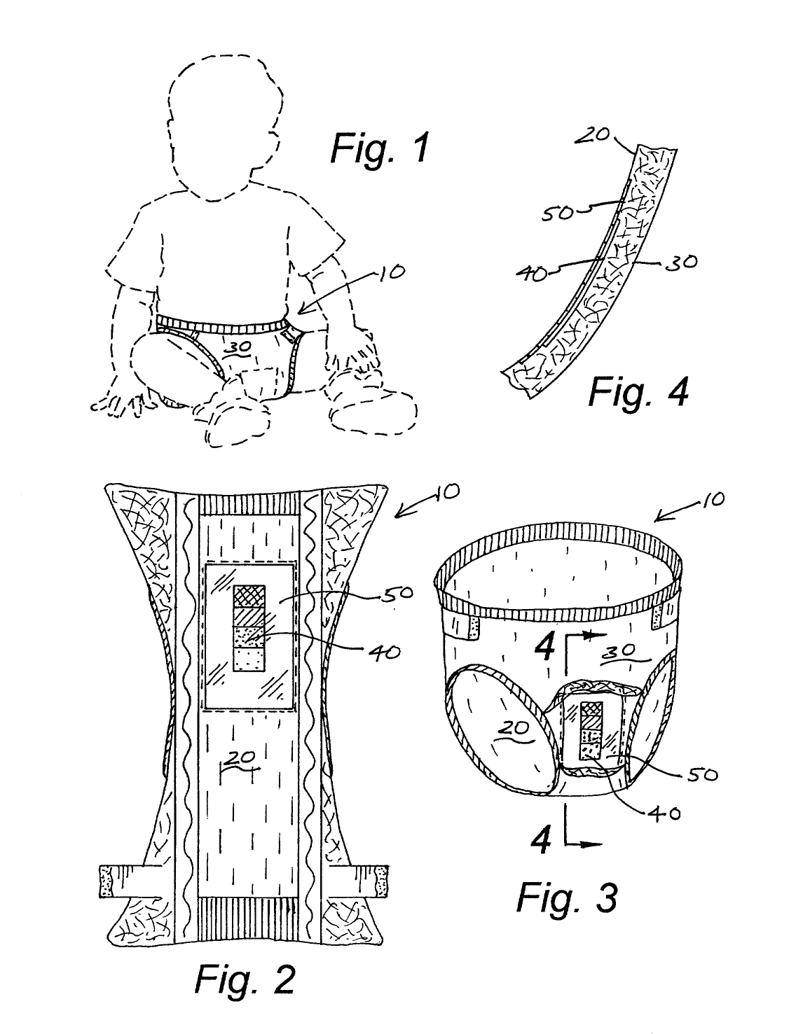

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of diaper condition sensing devices, and more particularly to a diaper with a pH indicator strip to show urine acidity.

2. Description of Related Art

As can be seen by reference to the following U.S. Pat. Nos. 5,469,145; 5,760,694; 5,790,035 and 5,838,240, the prior art is replete with myriad and diverse diaper condition sensing devices. reference number 10. The diaper 10 includes a diaper body with an inside surface 20 and an outside surface 30. An acidity indicator such as a pH indicator strip 40 is imbedded on the inside surface 20 and covered by a translucent cushion layer 50 that helps in keeping the skin dry.

This invention is useful, mostly for female babies, and will alert parents in advance as to whether or not their child may be developing a urinary tract infection. The pH indicator strip 40 will detect an infection of any kind while it is in the early stages. The pH strip 40 indicates the acidity of the urine. If acid in the urine is normal, the strip will turn a certain color. If the acid level is abnormal, it will turn a different color. By the color difference of the pH indicator strip 40, parents are able to discover the possibility of an infection before it advances to the stage where it can attack the baby's body.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

1. A diaper body having an inside surface and an outside surface; and
an acidity indicator disposed on the inside surface of the diaper body.

2. The diaper of claim 1 wherein the acidity indicator is a pH indicator strip attached to the inside surface of the diaper body.

3. The diaper of claim 2 further including a translucent cushion layer attached to the inside surface of the diaper body and disposed to overlie the pH indicator strip.
